(19) United States
(12) Patent Application Publication
(10) Pub. No.: US 2025/0310715 A1
(43) Pub. Date: Oct. 2, 2025

(54) TECHNIQUES FOR RENDERING AUDIO THROUGH A PLURALITY OF AUDIO OUTPUT DEVICES

(71) Applicant: HARMAN INTERNATIONAL INDUSTRIES, INCORPORATED, Stamford, CT (US)

(72) Inventors: Jianwen ZHENG, Guangdong Province (CN); Hongfei ZHOU, Guangdong Province (CN)

(21) Appl. No.: 18/863,935

(22) PCT Filed: May 9, 2022
(86) PCT No.: PCT/CN2022/091618

§ 371 Date: Nov. 7, 2024

(51) Int. Cl. H04S 7/00; H04R 3/00; H04R 5/04

(52) U.S. Cl. CPC H04S 7/303; H04R 3/005; H04R 5/04

(57) ABSTRACT

Techniques for generating audio include causing each audio output device of a plurality of audio output devices to output an audio sample; determining, for each other audio output device of the plurality of audio output devices, a detection time of the audio sample from each audio output device by each of two or more microphones included in the other audio output device; based on the detection times of each of the audio samples by each of the audio outputdevices, determining a location of each audio output device relative to the other audio output devices; and causing each of the plurality of audio output devices to generate an audio output associated with an audio object, wherein an output of each of the audio output devices is based on a location of the audio object and the location of each audio output device relative to the other audio output devices.

### BACKGROUND

### Field of the Various Embodiments

The various embodiments relate generally to audio output devices and, more specifically, to rendering audio through a plurality of audio output device.

### DESCRIPTION OF THE RELATED ART

Audio often includes a mixture of audio objects. For example, a soundtrack of a movie might include speech of one or more characters, sound effects from one or more events, environmental noise from the environment of the characters, and background music. As another example, music might include multiple components, such as singing, a rhythm guitar, a bass guitar, and a drum set. The audio can be captured by a microphone and presented live, recorded and subsequently played back, or synthesized by a device such as a computer.

It is often desirable to output the recorded or generated audio through a plurality of audio output devices, such as sets of wired or wireless speakers. The audio output devices are often positioned at certain locations within a physical space. For example, in a room organized as a home theater, a center speaker is positioned near the center of a front wall of the room, while front left, front right, rear left, and rear right speakers are each positioned in a corresponding corner of the room. A media device, such as a television or a computer, can transmit a signal to each speaker so that a listener within the physical space hears the combined output of all of the speakers.

In some cases, it is desirable to configure the audio output devices to output spatial audio, in which an audio object is perceived by a listener as coming from a particular location within the physical space. However, audio rendered by a plurality of audio output devices is affected by the distance between each audio output device and a listener. The speed of audio through the air between the audio output device and the listener affects the timing of the audio perceived by the listener, and the attenuation of the intensity through the air affects the volume of the audio perceived by the listener. Further, in such cases, the perceived direction of audio is affected by the angle between each audio output device and the listener. Due to these factors, the effectiveness of the spatial audio is affected by the locations of the audio output devices within the physical space.

In order to address these challenges, some audio systems include a user interface to adjust calibration settings. For example, an audio system might permit a user to set or adjust the volume level and/or latency of each audio output device, and a correct combination of settings might compensate for variable locations of the audio output devices. However, manual calibration processes can be complicated, which the user might find to be confusing or frustrating. The user might be unable to determine suitable settings for a particular arrangement of audio output devices, resulting in audio localization that is not better, and might be worse, than the original or default settings. Further, manual calibration settings of the audio output devices are applied equally to all audio objects, such as adjusting the intensity and delay of each speaker for all audio objects. As a result, the output of each speaker is modified for all audio objects, irrespective of different locations of the audio objects, or, further, different trajectories of the audio objects. Therefore, such calibration of the audio output devices can result in poor localization of the audio objects and/or inconsistent audio output of the audio output devices for different audio objects.

As the foregoing illustrates, what is needed are more effective techniques for rendering audio through a plurality of audio output devices.

### DETAILED DESCRIPTION

In various embodiments, a computer-implemented method of generating audio includes, causing each audio output device of a plurality of audio output devices to output an audio sample; determining, for each other audio output device of the plurality of audio output devices, a detection time of the audio sample from each audio output device by each of two or more microphones included in the other audio output device; based on the detection times of each of the audio samples by each of the audio output devices, determining a location of each audio output device relative to the other audio output devices; and causing each of the plurality of audio output devices to generate an audio output associated with an audio object, wherein an output of each of the audio output devices is based on a location of the audio object and the location of each audio output device relative to the other audio output devices.

At least one technical advantage of the disclosed techniques relative to the prior art is that, with the disclosed techniques, the output of each audio object by each audio output device is based on the location of the audio output device relative to the other audio output devices. As a result, a localization and/or trajectory of each audio object is more accurately rendered by the audio output devices based on their locations within a physical space. In addition, the disclosed calibration techniques can determine the location of each audio output device relative to the other audio output devices, including determining when the locations of two audio output devices are reversed. Further, the disclosed calibration techniques determine the locations of the audio output devices automatically and accurately, as compared with user-based adjustment of calibration settings. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a device configured according to various embodiments;

FIG. 2 is an illustration of a detection of a first audio output device by a second audio output device of FIG. 1, according to various embodiments;

FIG. 3 is an illustration of a portion of a calibration process for a plurality of audio output devices by the device of FIG. 1, according to various embodiments;

FIG. 4 is an illustration of another portion of a calibration process for a plurality of audio output devices by the device of FIG. 1, according to various embodiments;

FIG. 5 is an illustration of yet another portion of a calibration process for a plurality of audio output devices by the device of FIG. 1, according to various embodiments;

FIG. 6 is an illustration of a rendering of an audio object by a plurality of audio output devices by the device of FIG. 1, according to various embodiments;

FIG. 7 illustrates a flow diagram of method steps for calibrating the plurality of audio output devices of FIG. 1, according to various embodiments.

FIG. 8 illustrates a flow diagram of method steps for outputting an audio object by the plurality of audio output devices of FIG. 1, according to various embodiments.

### DETAILED DESCRIPTION

In the following description, numerous specific details are set forth to provide a more thorough understanding of the various embodiments. However, it will be apparent to one of skilled in the art that the inventive concepts can be practiced without one or more of these specific details.

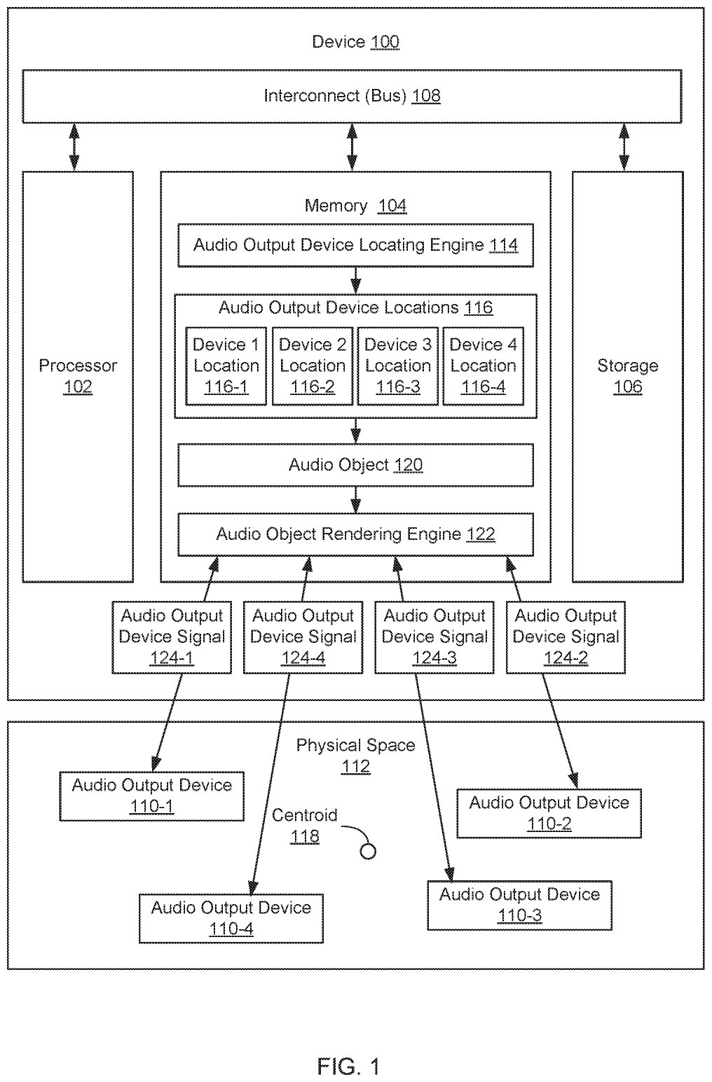

FIG. 1 illustrates a device 100 configured to implement one or more aspects of the various embodiments. As shown, the device 100 includes, without limitation, a processor 102, memory 104, storage 106, and an interconnect bus 108. As shown, the memory 104 includes, without limitation, an audio output device locating engine 114, an audio object 120, and an audio object rendering engine 122.

The processor 102 can be any suitable processor, such as a central processing unit (CPU), a graphics processing unit (GPU), an application-specific integrated circuit (ASIC), a field programmable gate array (FPGA), a digital signal processor (DSP), and/or any other type of processing unit, or a combination of different processing units, such as a CPU configured to operate in conjunction with a GPU. In general, the processor 102 can be any technically feasible hardware unit capable of processing data and/or executing software applications.

Memory 104 can include a random-access memory (RAM) module, a flash memory unit, or any other type of memory unit or combination thereof. The processor 102 is configured to read data from and write data to memory 104. Memory 104 includes various software programs an operating system, one or more applications) that can be executed by the processor 102 and application data associated with the software programs. Storage 106 can include non-volatile storage for applications and data and can include fixed or removable disk drives, flash memory devices, and CD-ROM, DVD-ROM, Blu-Ray, HD-DVD, or other magnetic, optical, or solid-state storage devices. The interconnect bus 108 connects the processor 102, the memory 104, the storage 106, and any other components of the device 100.

The device 100 is coupled to a plurality of audio output devices 110 located in a physical space 112. The plurality of audio output devices 110 can include, for example, a set of speakers in a home theater system. In some audio systems (e.g., a home theater system) that are capable of rendering spatial audio, each audio output device 110 corresponds to a particular channel corresponding to a certain location within the physical space 112, such as a front left channel, a front right channel, a rear left channel, and a rear right channel. In general and as shown, the audio output devices 110 are not respectively positioned at the corners of a regular polygon that might correspond to the expected locations of the channels. That is, rather than being positioned at the vertices of a square or a rectangle, the audio output devices 110-4 are positioned at the vertices of an irregular quadrilateral. As shown, the device 100 is coupled to four audio output devices 110, but various embodiments coupled be coupled to any number of audio output devices 110 (e.g., two, three, five, and/or six or more audio output devices).

As shown, the audio object rendering engine 122 is a program stored in the memory 104 and executed by the processor 102 to generate an audio output device signal 124 for each of the plurality of audio output devices 110. For example, in audio systems in which a first audio output device 110-1 is a front left speaker, the audio object rendering engine 122 transmits, to the first audio output device 110-1, a first audio output device signal 124-1 including a portion of sound from the audio object 120 that the listener should perceive from a front left corner of the physical space 112. The effectiveness of the rendered spatial audio (e.g., the clarity with which a listener perceives that the audio object 120 is positioned at a particular location within the physical space 112) is related to the accuracy with which the locations of the audio output devices 110 for the rendered audio object 120 match the actual locations of the audio output devices 110 within the physical space 112.

As shown, the audio output device locating engine 114 is a program stored in the memory 104 and executed by the processor 102 to determine the locations 116 of the audio output devices 110 within the physical space 112. That is, rather than defining each audio output device 110 as rendering a channel associated with a fixed location (e.g., a front left speaker that is expected to be positioned in a front left corner of the room), the device 100 performs a calibration process to detect the location of each audio output device 110 relative to the locations of the other audio output devices 110 within the physical space. Based on the calibration process, the device 100 stores a location 116 of each audio output device 110. For an audio object 120, the audio object rendering engine 122 uses the determined location 116 of each audio output device 110 to determine at least a portion of the sound of the audio object 120 to be generated as output by each audio output device 110.

While not shown in FIG. 1, in various embodiments, the device 100 renders audio of an audio object 120 according to a trajectory through the physical space 112, such as a line, circle, or arc. That is, the location of the audio object 120 within the physical space 112 changes over time. Based on the determined locations 116 of the audio output devices 110, the audio object rendering engine 122 can adjust the audio output device signals 124 of the respective audio output devices 110. For example, at a first time point, the trajectory of the audio object 120 might cause the audio object 120 to be positioned between the first audio output device 110-1 and the second audio output device 110-2. The audio object rendering engine 122 renders audio output device signals 124 in which the audio output device signals 124 for the first audio output device 110-1 and the second audio output device 110-2 at the first time point include at least a portion of the audio object 120, and the audio output device signals 124 for the third audio output device 110-3 and the fourth audio output device 110-4 at the first time point do not include a portion of the audio object 120. At a second time point, the trajectory of the audio object 120 might cause the audio object 120 to be positioned near the third audio output device 110-3. The audio object rendering engine 122 renders audio output device signals 124 in which the audio output device signals 124 for the third audio output device 110-3 at the second time point includes the audio object 120, and the audio output device signals 124 for the other audio output devices 110-1, 110-2, 110-4 at the second time point do not include a portion of the audio object 120.

While not shown in FIG. 1, in various embodiments, the device 100 renders audio of a plurality of audio objects 120, each of which may be associated with a location and/or trajectory within the physical space 112. For example, a first audio object 120 might be associated with a first trajectory that circles the plurality of audio output devices 110 in a clockwise direction, and a second audio object 120 might be associated with a second trajectory that circles the plurality of audio output devices 110 in a counterclockwise or anticlockwise direction. The audio object rendering engine 122 can generate the audio output device signal 124 for each audio output object 120 at each point in time to include a first component corresponding to at least a portion of the first audio object 120 and/or a second component corresponding to a portion of the second audio object 120. That is, the audio output device signal 124 for each audio output device 110 includes a sum of the portions of the respective audio objects 120. As a result, the audio output device signal 124 for each audio output device 110 includes a combination or superposition of the audio associated with the respective audio objects 120 that are to be rendered by the audio output device 110 at each time point.

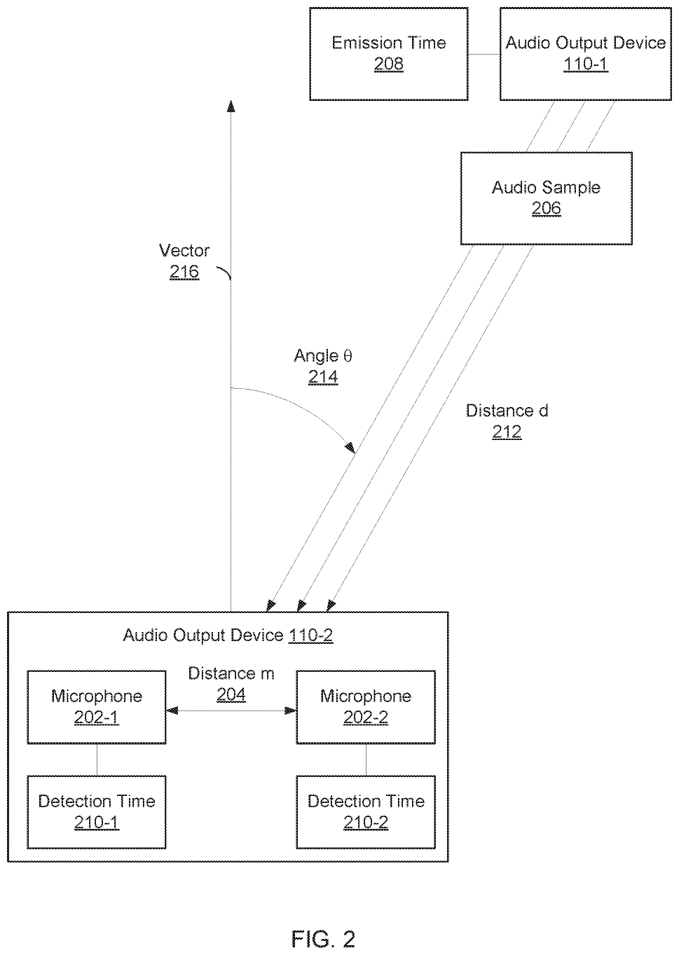

FIG. 2 is an illustration of a detection of a first audio output device 110-1 by a second audio output device 110-2 of FIG. 1, according to various embodiments. As shown, the second audio output device 110 includes two microphones 202-1, 202-2.

During calibration, the first audio output device 110-1 emits an audio sample 206 at an emission time 208. For example, the audio sample 206 can include a tone of a given frequency, a frequency sweep over a portion of a human-audible frequency range and/or a human-inaudible frequency range, white or pink noise, or the like. The second audio output device 110-2 includes two microphones 202-1, 202-2 that are spaced apart by a distance 204. For example, within the audio output device 110-2, the first microphone 202-1 could be positioned at the left side, and the second microphone 202-2 could be positioned at the right side, with a spatial separation of 0.3 meters. Due to the speed of the audio sample 206 traveling through the air, the first microphone 202-1 detects the audio sample 206 at a first detection time 210-1, and the second microphone 202-2 that detects the audio sample 206 at a second detection time 210-2. As shown, because the first audio output device 110-1 is positioned to the right of the second audio output device 110-2, the audio sample 206 reaches the second microphone 202-2 on the right side of the second audio output device 110-2 before reaching the first microphone 202-1 on the left side of the second audio output device 110-2. That is, the second detection time 210-2 occurs before the first detection time 210-1.

Based on the detection times 210-1, 210-2 and the emission time 208, the audio output device locating engine 114 can determine a distance 212 between the first audio output device 110-1 and the second audio output device 110-2. In various embodiments, the audio output device locating engine 114 determines the distance 212 based on the following equation:

$$d = \frac{( {T}_{left} + {T}_{right} ) \cdot c}{2} , \qquad EQ . 1$$

wherein,
d represents the distance between the first audio output device 110-1 and the second audio output device 110-2,
T_{left} represents a difference between the first detection time 210-1 of the first microphone 202-1 and the emission time 208,
T_{right} represents a difference between the second detection time 210-2 of the second microphone 202-2 and the emission time 208, and
c represents the speed of sound through the air.

Also, based on the detection times 210-1, 210-2 and the emission time 208, the audio output device locating engine 114 can determine an angle 214 between the first audio output device 110-1 and the second audio output device 110-2 relative to a vector 216. In various embodiments, the audio output device locating engine 114 determines the angle 214 based on the following equation:

$$θ = {sin}^{- 1} ( \frac{( {T}_{left} - {T}_{right} ) \cdot c}{m} ) , \qquad EQ . 2$$

wherein,
θ represents the angle between the first audio output device 110-1 and the second audio output device 110-2 relative to an outward vector that is normal to the line between the first microphone 202-1 and the second microphone 202-2,
m represents the distance between the first microphone 202-1 and the second microphone 202-2 of the first audio output device 110-1,
T_{left} represents a difference between the first detection time 210-1 of the first microphone 202-1 and the emission time 208,
T_{right} represents a difference between the second detection time 210-2 of the second microphone 202-2 and the emission time 208, and
c represents the speed of sound through the air.

While not shown, in various embodiments, the determination of the distance 212 and the angle 214 can be performed by the device 100 (e.g., the audio output device locating engine 114), the first audio output device 110-1, the second audio output device 110-2, and/or any other device that is capable of evaluating EQ. 1 and EQ. 2. In various embodiments, the distance 212 and/or angle 214 can be determined according to equations other than EQ. 1 and EQ. 2. For example, in some embodiments, the distance 212 and/or angle 214 can be determined in the absence of a detected and/or recorded emission time 208, but based on the aggregate detection times 210 of two or more other audio output devices 110 of the plurality of audio output devices 110.

While not shown, in various embodiments, the audio output device locating engine 114 performs the calibration in which each audio output device 110 of the plurality of audio output devices 110 emits an audio sample 206 at a different time. Alternatively, while not shown, in various embodiments, at least two of the plurality of audio output devices 110 concurrently emit audio samples 206, such as different audio output device 110 emitting audio samples 206 at different frequencies at a given time point, or different audio output device 110 emitting audio samples 206 with an audio sweep over different frequency ranges, sweep durations, and/or time periods.

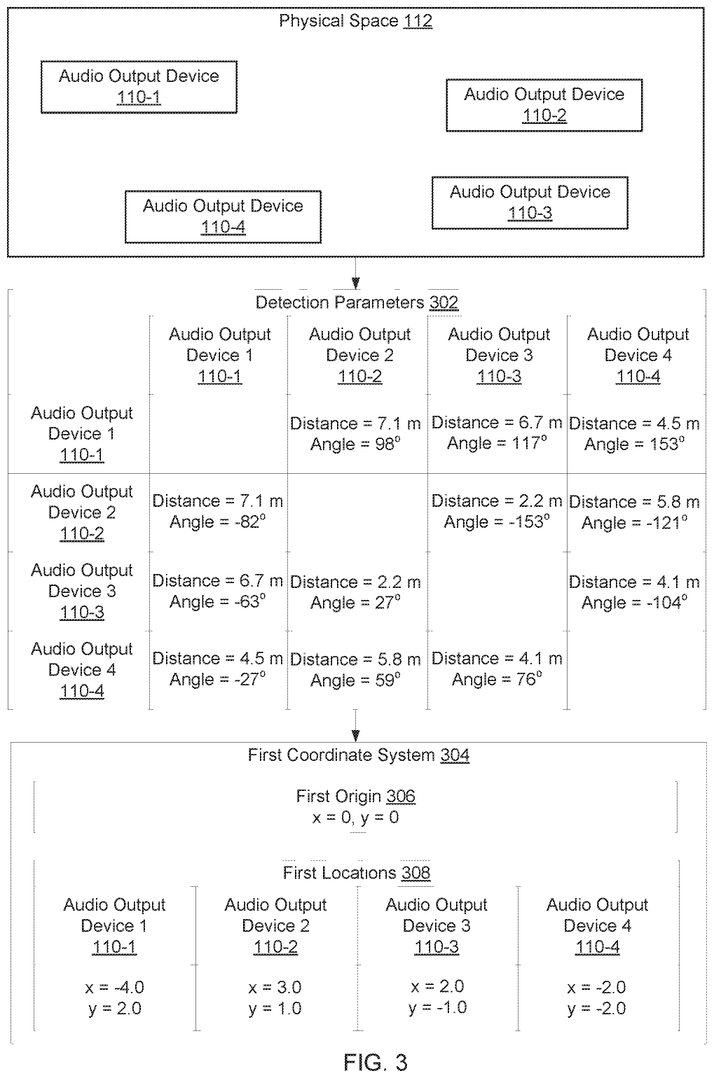

FIG. 3 is an illustration of a portion of a calibration process for a plurality of audio output devices by the device 100 of FIG. 1, according to various embodiments. As shown, the portion of the calibration process includes a determination of first locations 308 of a plurality of audio output devices 110 within a physical space 112. In various embodiments, the audio output device locating engine 114 of FIG. 1 performs this portion of the calibration process.

As shown, the plurality of audio output devices 110 is associated with a set of detection parameters 302. The set of detection parameters 302 includes, for each first audio output device 110 and each second audio output device 110, a determination of a distance 212 between the first audio output device 110 and the second audio output device 110, and a determination of an angle 214 between the first audio output device 110 and the second audio output device 110 (e.g., relative to a vector 216, such as a north vector or other direction within the physical space 112). In various embodiments, the audio output device locating engine 114 determines the distances 212 and/or angles 214 between each pair of audio output devices 110 based on a detection of each first audio output device 110-1 by each second audio output device 110-2, such as shown in FIG. 2.

As shown, based on the detection parameters, the audio output device locating engine 114 determines a first location 308 of each audio output device 110 within a first coordinate system 304. In various embodiments, the audio output device locating engine 114 determines the first locations 308 relative to a first origin 306 of the first coordinate system 304. For example, the first origin 306 can be based on a geometric center of the physical space 112 or a center of a rectangular boundary encompassing the plurality of audio output devices 110. In various embodiments, the audio output device locating engine 114 selects the first origin 306 arbitrarily (e.g., any point that is inside or outside of a polygon with vertices at the locations of the audio output devices 110). Based on the first origin 306 and the detection parameters 302, the audio output device locating engine 114 determines a first location 308 for each audio output device 110, such as a first coordinate within the first coordinate system 304 relative to the first origin 306. In various embodiments, the first locations 308 are consistent with and/or proportional to, the detection parameters 302. For example, the geometric distances between each pair of audio output devices 110 within the first coordinate system 304 are consistent with and/or proportional to the distances between each pair of the audio output devices 110 within the physical space 112. As shown, the first coordinate system 304 is a Cartesian coordinate system, but various embodiments can include other types of first coordinate systems, such as polar coordinate systems or spherical coordinate systems.

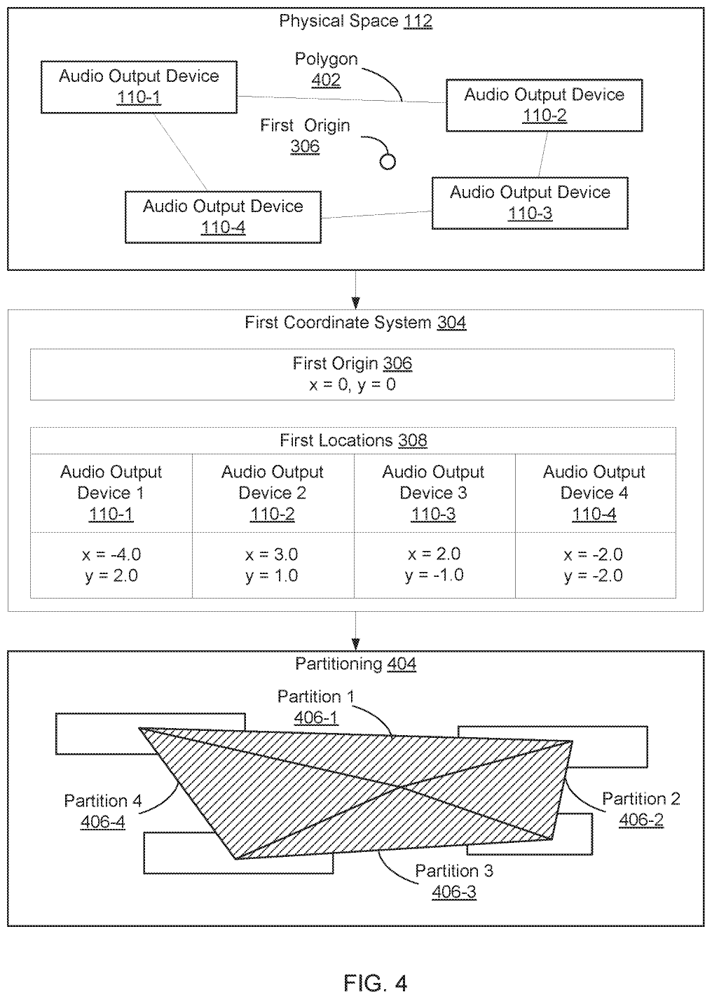

FIG. 4 is an illustration of another portion of a calibration process for a plurality of audio output devices 110 by the device 100 of FIG. 1, according to various embodiments. As shown, the portion of the calibration process includes a partitioning 404 of a plurality of audio output devices 110 within a physical space 112. In various embodiments, the audio output device locating engine 114 of FIG. 1 performs this portion of the calibration process.

As previously discussed, the audio output device locating engine 114 determines, for each audio output device 110, a first location 308 within a first coordinate system 304. In various embodiments, the audio output device locating engine 114 determines the first locations 308 of the audio output devices 110 within the first coordinate system 304 and relative to the first origin 306, such as shown in FIG. 3. The determined first locations 308 form a polygon 402, wherein the first location 308 of each audio output device 110 corresponds to a vertex of the polygon 402. Based on the first locations 308 and the first origin 306, the audio output device locating engine 114 performs a partitioning 404 of the plurality of audio output devices 110 into a set of partitions 406, wherein each partition 406 is based on the first origin 306 and the first locations 308 of a subset of the audio output devices 110 selected in a predetermined sequence. As shown, each partition 406 includes a triangle with a first vertex corresponding to the first origin 306 and two vertices corresponding to the respective first locations 308 of a first audio output device 110 and a second audio output device 110. As shown, for a given set of four audio output devices 110, the audio output device locating engine 114 generates four partitions 406 corresponding to the following pairs of audio output devices: (110-1, 110-2), (110-2, 110-3), (110-3, 110-4), and (110-4, 110-1). In various embodiments, the audio output device locating engine 114 determines the partitions 406 differently, such as triangles respectively including vertices corresponding to the first locations 308 of three audio output devices 110, or quadrilaterals respectively including a first vertex corresponding to the first origin 306 and three vertices corresponding to the respective first locations 308 of three audio output devices 110.

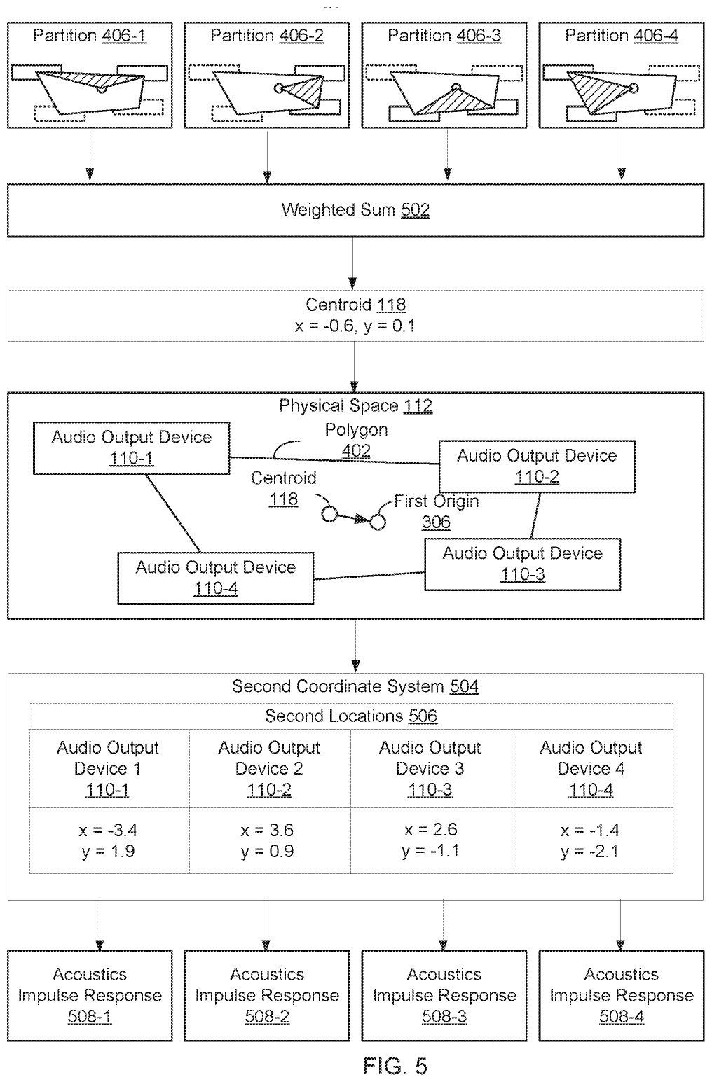

FIG. 5 is an illustration of yet another portion of a calibration process for a plurality of audio output devices 110 by the device of FIG. 1, according to various embodiments. As shown, the portion of the calibration process includes a determination of locations of the audio output devices 110 within a second coordinate system 504. In various embodiments, the audio output device locating engine 114 of FIG. 1 performs this portion of the calibration process.

As previously discussed, the audio output device locating engine 114 determines partitions 406 of the one or more audio output devices 110. In various embodiments, the audio output device locating engine 114 determines the partitions 406 based on the vertices of the plurality of audio output devices 110 within a first coordinate system 304 and relative to a first origin 306 of the first coordinate system 304, such as shown in FIG. 4. The audio output device locating engine 114 evaluates each partition 406 to determine an area of each partition 406-1, 406-2, 406-3, 406-4. In various embodiments, the audio output device locating engine 114 determines the area of each partition 406 based on the following equation when triangles are used:

$${S}_{i} = \frac{{x}_{i} {y}_{i + 1} - {x}_{i + 1} {y}_{i}}{2} , \qquad EQ . 3$$

wherein,
Sᵢ represents the area of an i^{th} partition of the polygon 402 including a first audio output device i and a second audio output device i+1,
xᵢ represents the x-coordinate of the first audio output device i within the first coordinate system 304,
yᵢ represents the y-coordinate of the first audio output device i within the first coordinate system 304,
xᵢ₊₁ represents the x-coordinate of the second audio output device i+1 within the first coordinate system 304, and
yᵢ₊₁ represents the y-coordinate of the second audio output device i+1 within the first coordinate system 304.

In various embodiments, the audio output device locating engine 114 further determines a center of each partition 406 based on the following equations:

$$\overline{{x}_{ι}} = \frac{{x}_{i} + {x}_{i + 1}}{3} \qquad EQ . 4$$

$$\overline{{y}_{ι}} = \frac{{y}_{i} + {y}_{i + 1}}{3} \qquad EQ . 5$$

wherein,
x̅ᵢ, represents the x-coordinate of the center of an i^{th} partition including a first audio output device i and a second audio output device i+1,
xᵢ represents the x-coordinate of the first audio output device i within the first coordinate system 304,
yᵢ represents the y-coordinate of the first audio output device i within the first coordinate system 304,
y̅ᵢ represents the y-coordinate of the center of the i^{th} partition,
xᵢ₊₁ represents the x-coordinate of the second audio output device i+1 within the first coordinate system 304, and
yᵢ₊₁ represents the y-coordinate of the second audio output device i+1 within the first coordinate system 304.

The audio output device locating engine 114 further determines a centroid 118 of the polygon 402 based on the areas and centers of the partitions 406. As shown, the audio output device locating engine 114 determines the centroid 118 based on a weighted sum 502 of the partitions 406. The weighted sum 502 includes a sum of the products of the center of each partition 406 and the area of each partition 406. As shown, the device determines that the centroid 118 is located at (x_{c}=−0.6, y_{c}=0.1) in the first coordinate system 304. In various embodiments, the audio output device locating engine 114 determines the centroid 118 of the polygon 402 based on the following equations:

$${x}_{c} = \frac{{\sum }_{i = 1}^{N} {S}_{i} \overline{{x}_{ι}}}{{\sum }_{i = 1}^{N} {S}_{i}} \qquad EQ . 6$$

$${y}_{c} = \frac{{\sum }_{i = 1}^{N} {S}_{i} \overline{{y}_{ι}}}{{Σ}_{i = 1}^{N} {S}_{i}} \qquad EQ . 7$$

wherein,
x_{c} represents the x-coordinate of the centroid 118 within the first coordinate system 304,
N represents the number of audio output devices 110,
Sᵢ represents the area of an i^{th} partition of the polygon 402,
x̅ᵢ represents the x-coordinate of the center of the i^{th} partition,
y_{c} represents the y-coordinate of the centroid 118 within the first coordinate system 304, and
y̅ᵢ represents the y-coordinate of the center of the i^{th} partition.

Based on the centroid 118, the audio output device locating engine 114 determines a second location 506 of each audio output device 110 within a second coordinate system 504. In various embodiments, the second coordinate system 504 can be of a same or similar type as the first coordinate system 304. As shown, the second coordinate system 504 is another Cartesian coordinate system in which the first coordinate system 304 is offset by a difference between the coordinates of the first origin 306 and the coordinates of the centroid 118. That is, the second coordinate system 504 is the first coordinate system 304 with the origin translated to the centroid 118. As shown, the audio output device locating engine 114 further determines each second location 506 within the second coordinate system 504 by subtracting, from the coordinates of each corresponding first location 308, a difference between the coordinates of the first origin 306 within the first coordinate system 304 and the coordinates of the centroid 118 within the first coordinate system 304. While not shown, in various embodiments, the second coordinate system 504 can be of a different type than the first coordinate system 304. For example, the first coordinate system 304 could be a Cartesian coordinate system, and the second coordinate system 504 could be a polar coordinate system or a spherical coordinate system.

In various embodiments, the audio output device locating engine 114 determines second locations of each audio output device 110 within the second coordinate system 504 based on the following equations:

$${x}_{i 2} = {x}_{i} - {x}_{c} \qquad EQ . 8$$

$${y}_{i 2} = {y}_{i} - {y}_{c} \qquad EQ . 9$$

wherein,
xᵢ₂ represents the x-coordinate of an audio output device i within the second coordinate system 504,
xᵢ represents the x-coordinate of the audio output device i within the first coordinate system 304,
x_{c} represents the x-coordinate of the centroid 118 within the first coordinate system 304,
yᵢ₂ represents the y-coordinate of the audio output device i within the second coordinate system 504,
yᵢ represents the y-coordinate of the audio output device i within the first coordinate system 304, and
y_{c} represents the y-coordinate of the centroid 118 within the first coordinate system 304.

As shown, the audio output device locating engine 114 determines an acoustics impulse response 508 for each audio output device 110. In various embodiments, each acoustics impulse response 508 includes a transfer function that indicates how the audio output device 110 alters the audio emitted by the audio object 120 at various locations. Applying the acoustics impulse response 508 to a representation of an audio object 120 transforms how each frequency emitted by the audio object 120 would be perceived if emitted from, emitted through, and/or reflected at the second location 506 of the audio output device 110. The acoustics impulse response 508 determined for each audio output device 110 therefore alters the output of the audio object 120 by the audio output device 110 so that a listener located within the physical space 112 perceives a current location of the audio object 120. In various embodiments, the audio output device locating engine 114 determines the acoustics impulse response 508 of each audio output device 110 based on the second location 506 of the audio output device 110 within the second coordinate system 504 and an acoustic model, such as (without limitation) a point-source acoustics model, a plane-wave acoustics model, or the like. The audio output device locating engine 114 can store (e.g., in the memory 104 or the storage 106) the acoustics impulse response 508 for each audio output device 110 for use by the audio object rendering engine 122 while rendering audio objects 120.

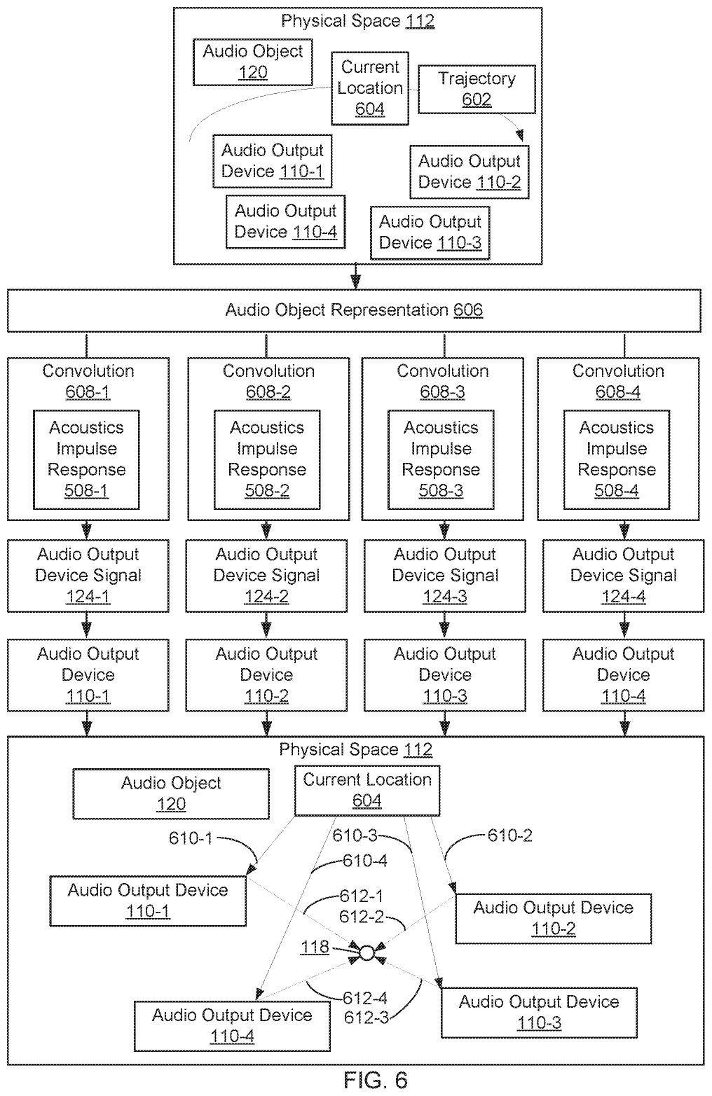

FIG. 6 is an illustration of a rendering of an audio object by a plurality of audio output devices 110 by the device 100 of FIG. 1, according to various embodiments. In various embodiments, the audio object rendering engine 122 of FIG. 1 performs the rendering.

In various embodiments, an audio object 120 follows a trajectory 602 within the physical space 112 of the plurality of audio output devices 110. As shown, the trajectory 602 of the audio object 120 begins at a first location near a first audio output device 110-1, follows a curved path adjacent from the first location near the first audio output device 110-1 to a second location near a second audio output device 110-2, and ends at the second location near the second audio output device 110-2. As a result, at each time point, the audio object 120 is located at a current location 604 along the trajectory. Thus, at each time point, the audio object rendering engine 122 transmits, to each audio output device 110, an audio output device signal 124 in which the audio object 120 is adjusted based on the current location 604 of the audio object 120 relative to the audio output device location 116 of the audio output device 110. For example, at the first time point, the audio object rendering engine 122 includes a majority of the sound from the audio object 120 in the audio output device signal 124 for the first audio output device 110-1. At the second time point, the audio object rendering engine 122 includes a first portion of the audio object 120 in the first audio output device signal 124-1 for the first audio output device 110-1 and a second portion of the audio object 120 in a second audio output device signal 124-2 for the second audio output device 110-2. At the third time point, the audio object rendering engine 122 includes a majority of the sound from the audio object 120 in the audio output device signal 124-2 for the second audio output device 110-2. At each time point, each audio output device 110 outputs the audio of the audio object 120 as if originating from the location of the audio object 120 within the physical space 112 and reflecting off of the audio output device 110 before reaching the user.

In various embodiments, each audio object 120 includes an audio object representation 606 of the audio object 120. For example, each audio object representation 606 can include an audio sample of the sounds emitted by the audio object 120. Each audio object representation 606 can further include a source description of the trajectory 602, such as a set of coordinates within the first coordinate system 304 that indicate the current location 604 of the audio object 120 at various time points. The audio object rendering engine 122 can determine, for the audio object 120, a set of second locations 506 within the second coordinate system 504. For example, the audio object rendering engine 122 can subtract, from each first coordinate of the source description within the first coordinate system 304, the difference between the first origin 306 within the first coordinate system 304 and the centroid 118 within the first coordinate system 304, thereby generating the second locations 506 of the source description within the second coordinate system 504. As shown, each audio output device 110 outputs the audio of the audio object 120 as if originating from the location of the audio object 120 within the physical space 112 (along a first line 610) and reflecting off of the audio output device 110 before reaching the centroid 118 (along a second line 612).

In various embodiments, the audio object rendering engine 122 generates an audio output device signal 124 for each audio output device 110 based on an acoustics impulse response 508 of the audio output device 110 and an audio object representation 606 of the audio object 120. As shown, the audio object rendering engine 122 performs a convolution operation 608 between the audio object representation 606 and the acoustics impulse response 508 of each audio output device 110. In various embodiments, for each audio object 120, the audio object rendering engine 122 performs the convolution operation 608 based on the following equation:

$${R}_{i} ( n ) = {h}_{i} ( n ) * D ( n ) \qquad EQ . 10$$

wherein,
i represents an audio output device i of the plurality of audio output devices 110,
n represents a time point,
Rᵢ(n) represents the audio output device signal 124 for the audio object by the audio output device i,
hᵢ(n) represents the acoustics impulse response 508 of the audio output device i,
D(n) represents the audio object representation 606 of the audio object 120, and
hᵢ(n)*D(n) represents a convolution operation 608 between the acoustics impulse response 508 of the audio output device i and the audio object representation 606 of the audio object 120.

Each convolution operation 608 adjusts the audio object representation 606 of the audio object 120 to render the sound as if originating from the location of the audio object 120 within the physical space 112 (along a first line 610) and reflecting off of the audio output device 110 before reaching the user (along a second line 612). For example, the first convolution operation 608-1 of the audio object representation 606 with the acoustics impulse response 508-1 of the first audio output device 110 causes the audio emitted by the audio object 120 to be perceived as if being emitted from the current location 604 of the audio object 120, traveling through the air along the first line 610-1 to the second location 506 of the first audio output device 110-1, reflecting off the first audio output device 110-1, and traveling down the second line 612-1 to reach the centroid 118. Similarly, the other convolution operations 608-2, 608-3, 608-4 of the audio object representation 606 with the acoustics impulse responses 508-2, 508-3, 508-4 of the other audio output devices 110-2, 110-3, 110-4 cause the audio object 120 to be perceived as if being emitted from the current location 604 of the audio object 120, traveling through the air along another first line 610-2, 610-3, 610-4 to the second locations 506 of one of the other audio output devices 110-2, 110-3, 110-4, reflecting off one of the other audio output device 110-2, 110-3, 110-4, and traveling down another second line 612-2, 612-3, 612-4 to reach the centroid 118. A listener within the physical space 112 perceives the combined audio output of each of the audio output devices 110 and therefore perceives the audio object 120 as if it were located in the current location 604 of the trajectory 602.

Further, in various embodiments, the audio object rendering engine 122 generates an audio output device signal 124 for each audio output device 110 for a plurality of audio objects 120. For example, each audio output device 110 can concurrently output rendered audio for each of several audio objects 120. In various embodiments, the audio object rendering engine 122 generates a component Rᵢ(n) of the audio output device signal 124 for each audio object 120, and transmits, to the audio output device 110, an aggregation (e.g., a sum) of the components Rᵢ(n) for each of the audio objects 120. In various embodiments, for each audio object 120, the audio object rendering engine 122 performs the convolution operation 608 based on the following equation:

$${R}_{i} ( n ) = {\sum }_{m = 1}^{M} {h}_{i} ( n ) * {D}_{m} ( n ) \qquad EQ . 11$$

wherein,
i represents an audio output device i of the plurality of audio output devices 110,
n represents a time point,
Rᵢ(n) represents the audio output device signal 124 for the plurality of audio objects 120 by the audio output device i,
hᵢ(n) represents the acoustics impulse response 508 of the audio output device i,
M represents the number of audio objects 120,
Dₘ(n) represents the audio object representation 606 of an audio object m of the M audio objects 120, and
hᵢ(n)*Dₘ(n) represents a convolution operation between the acoustics impulse response 508 of the audio output device i and the audio object representation 606 of the audio object m of the M audio objects 120.

As shown, the audio object rendering engine 122 transmits, to each audio output device 110, the audio output device signal 124 generated for the audio output device 110 based on the current location 604 and/or trajectory 602 of each of one or more audio objects 120. In various embodiments, the audio object rendering engine 122 transmits the audio output device signal 124 through a wire (e.g., a two-wire audio speaker cable) or via a wireless signal (e.g., a Bluetooth signal, a wireless network signal). Each audio output device 110 outputs the corresponding audio output device signal 124. As a result, the device 100 renders one or more audio objects 120 that a listener perceives as originating from one or more current locations 604 along a trajectory 602.

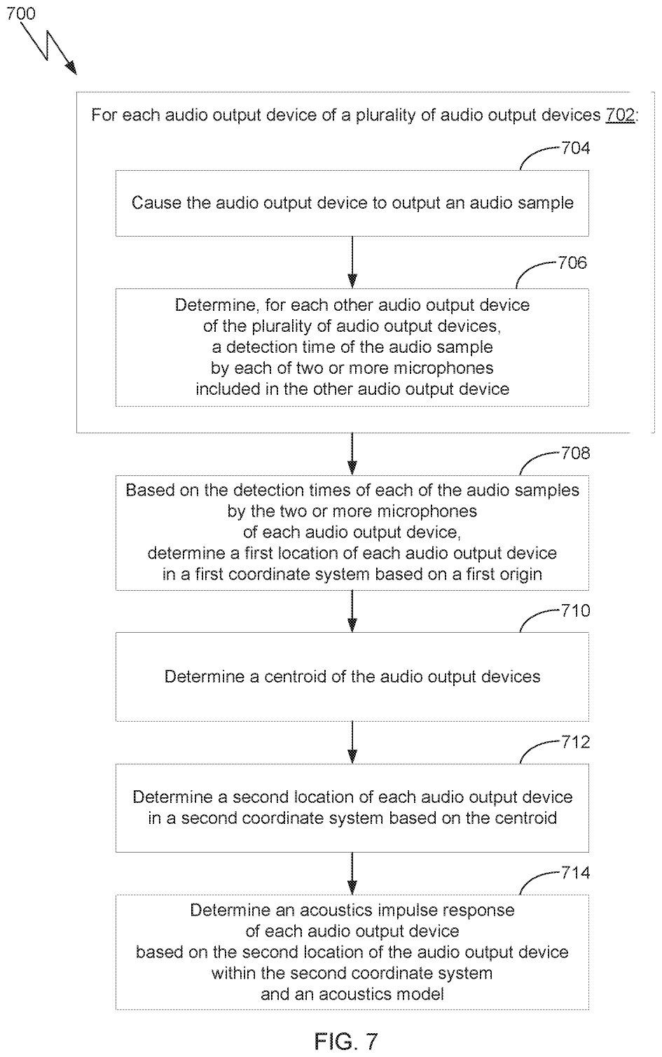

FIG. 7 illustrates a flow diagram of method steps for calibrating the plurality of audio output devices of FIG. 1, according to various embodiments. The method steps of FIG. 7 can be applied, e.g., by the audio output device locating engine 114 of FIG. 1. Although the method steps of FIG. 7 are described with respect to the device 100 of FIG. 1 and the techniques illustrated in FIGS. 2-6, many systems configured to perform the method steps, in any order, can fall within the scope of the various embodiments.

As shown, a method 700 begins with a step 702 performed for each audio output device of a plurality of audio output devices. At step 704, the audio output device locating engine causes the audio output device to output an audio sample. For example, the audio output device can output a tone of a given frequency, a frequency sweep over a portion of a human-audible frequency range and/or a human-inaudible frequency range, white or pink noise, or the like. At step 706, the audio output device locating engine determines, for each of the other audio output devices of the plurality of audio output devices, a detection time of the audio sample by each of two or more microphones included in the other audio output device. For example, each audio output device can include a left microphone and a right microphone, and the audio output device locating engine can determine a first detection time of the audio sample by the left microphone of each audio output device and a second detection time of the audio sample by the right microphone of each audio output device. The detecting can include determining a distance of the audio output device outputting the audio sample from each other audio output device of the plurality of audio output devices. The detecting can include determining an angle of the audio output device outputting the audio sample from each other audio output device of the plurality of audio output devices, relative to an outward vector normal to a line connecting the microphones of the other audio output device. In various embodiments, the audio output device locating engine can determine the distances and/or angles between respective pairs of audio output devices as described above with respect to the embodiments of FIG. 2.

At step 708, based on the detection times of each of the audio samples by each of the two or more microphones of each of the audio output devices, the audio output device locating engine determines a first location of each audio output device in a first coordinate system relative to a first origin. For example, the first origin can be based on a geometric center of the physical space or a center of a rectangular boundary encompassing the plurality of audio output devices, or any point within a physical space. The determining can include determining a coordinate of each audio output device within the first coordinate system relative to the first origin. In various embodiments, the audio output device locating engine can determine the first location of each audio output device as described above with respect to the embodiments of FIG. 3.

At step 710, the audio output device locating engine determines a centroid of the audio output devices. For example, the centroid can be a centroid of a polygon including vertices based on the first locations of the audio output devices within the first coordinate system. The audio output device locating engine can determine the centroid based on a weighted sum of partitions of the polygon. In various embodiments, the audio output device locating engine can determine the polygon and the partitions of the polygon as described above with respect to the embodiments of FIG. 4. In various embodiments, the audio output device locating engine can determine a centroid of the polygon in a second coordinate system as described above with respect to the embodiments of FIG. 5.

At step 712, the audio output device locating engine determines a second location of each audio output device in a second coordinate system based on the centroid. For example, the audio output device locating engine can subtract, from the first location of each audio output device within a first coordinate system, a difference between a first origin of the first coordinate system and the determined centroid of a polygon within the first coordinate system. The second locations indicate the locations of the audio output devices within the second coordinate system relative to the centroid. In various embodiments, the audio output device locating engine can determine second locations of the audio output devices in a second coordinate system as described above with respect to the embodiments of FIG. 5.

At step 714, the audio output device locating engine determines an acoustics impulse response of each audio output device based on the second location of the audio output device within the second coordinate system and an acoustics model. For example, the audio output device locating engine can determine the acoustics impulse response of each audio output device based on a point-source acoustics model or a plane-wave acoustics model. The audio output device locating engine can store the acoustics impulse response of each audio output device in the memory and/or storage of the device for use by an audio object rendering engine to render audio objects. In various embodiments, the audio output device locating engine can determine the acoustics impulse response of each audio output devices as described above with respect to the embodiments of FIG. 5.

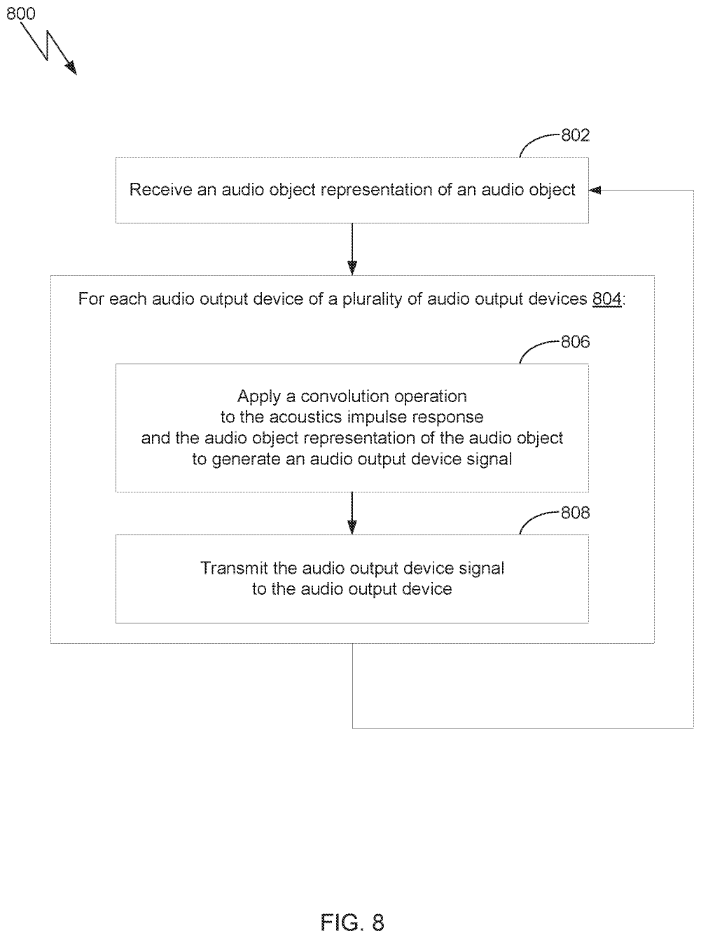

FIG. 8 illustrates a flow diagram of method steps for outputting an audio object by the plurality of audio output devices of FIG. 1, according to various embodiments. The method steps of FIG. 8 can be applied, e.g., by the audio object rendering engine 122 of FIG. 1. Although the method steps of FIG. 8 are described with respect to the device 100 of FIG. 1, many systems configured to perform the method steps, in any order, can fall within the scope of the various embodiments.

As shown, a method 800 begins at step 802 in which the audio object rendering engine receives an audio object representation of an audio object. For example, the audio object rendering engine can retrieve the audio object representation from a memory and/or storage of the device, or can receive the audio object representation from another device. The audio object representation can include a source description of the audio object, including a set of one or more first locations of the audio object within a first coordinate system. In various embodiments, the audio output rendering engine receives audio object representations of a plurality of audio objects.

At step 804, the audio object rendering engine performs a step for each audio output device of the plurality of audio output devices. At step 806, the audio object rendering engine applies a convolution operation to the acoustics impulse response and the audio object representation of the audio object to generate an audio output device signal for the audio output device. The audio output device signal includes, for the audio output device, a rendering of the audio transmitted from a current location of the audio object and reflected from the second location of the audio output device within the second coordinate system. In various embodiments, the audio output rendering engine applies the convolution operation to each audio object representation of a plurality of audio objects, applies the convolution operation to the acoustics impulse response of the audio output device each of the audio object representation, and generates an audio output device signal including a sum of the outputs of the convolution operations. At step 808, the audio object rendering engine transmits the audio output device signal to the audio output device. The audio object rendering engine can return to step 802 to receive additional audio objects for further rendering by the plurality of audio output devices. In various embodiments, the audio output device locating engine can render an audio object and cause the audio output devices to output spatial audio including the audio object as described above with respect to the embodiments of FIG. 6.

In sum, techniques for generating audio include causing each audio output device of a plurality of audio output devices to output an audio sample. While each audio output device outputs the audio sample, a detection time of the audio sample is determined for each other audio output device of the plurality of audio output devices, and, specifically, by each of two or more microphones included in the other audio output device. Based on the detection times of each of the audio samples by each of the audio output devices, a distance and angle of each audio output device relative to each other audio output device is determined.

Each audio output device outputs one or more audio objects. The output of each audio object by each audio output device is based on the location of the audio output device relative to the other audio output devices within a second coordinate system. Basing the output of each audio object on the location of each audio output device relative to the other audio output devices can improve a localization of the audio object within a physical space of the audio output devices.

At least one technical advantage of the disclosed techniques relative to the prior art is that, with the disclosed techniques, the output of each audio object by each audio output device is based on the location of the audio output device relative to the other audio output devices. As a result, a localization and/or trajectory of each audio object is more accurately rendered by the audio output devices based on their locations within a physical space. In addition, the disclosed calibration techniques can determine the location of each audio output device relative to the other audio output devices, including determining when the locations of two audio output devices are reversed. Further, the disclosed calibration techniques determine the locations of the audio output devices automatically and accurately, as compared with user-based adjustment of calibration settings. These technical advantages provide one or more technological improvements over prior art approaches.

1. In some embodiments, a computer-implemented method of generating audio comprises causing each audio output device of a plurality of audio output devices to output an audio sample; determining, for each other audio output device of the plurality of audio output devices, a detection time of the audio sample from each audio output device by each of two or more microphones included in the other audio output device; based on the detection times of each of the audio samples by each of the audio output devices, determining a location of each audio output device relative to the other audio output devices; and causing each of the plurality of audio output devices to generate an audio output associated with an audio object, wherein an output of each of the audio output devices is based on a location of the audio object and the location of each audio output device relative to the other audio output devices.

2. The computer-implemented method of clause 1, wherein determining the location of a first audio output device of the plurality of audio output devices relative to the audio output device outputting the audio sample comprises: determining a difference between a first detection time of the audio sample by a first microphone of the first audio output device and a second detection time of the audio sample by a second microphone of the first audio output device, and determining, based on the difference, an angle between the first audio output device and the audio output device outputting the audio sample.

3. The computer-implemented method of clauses 1 or 2, wherein determining the location of a first audio output device of the plurality of audio output devices relative to the audio output device outputting the audio sample comprises: determining a difference between an emission time of the audio sample and a detection time of the audio sample by at least one of the two or more microphones of the first audio output device, and determining, based on the difference, a distance between the first audio output device and the audio output device outputting the audio sample.

4. The computer-implemented method of any of clauses 1-3, wherein determining the location of each audio output device relative to the other audio output devices comprises: determining a centroid of the plurality of audio output devices in a first coordinate system, and determining the location of each audio output device relative to the centroid.

5. The computer-implemented method of any of clauses 1-4, wherein determining the location of each audio output device relative to the other audio output devices comprises: for one or more pairs of the plurality of audio output devices, determining a triangle including an origin of a first coordinate system and a first location of each audio output device of the pair in the first coordinate system, and determining a centroid of the plurality of audio output devices based on a weighted sum of centers of each triangle, wherein the weighted sum is based on areas of the triangles.

6. The computer-implemented method of any of clauses 1-5, further comprising: determining a second location of each audio output device within a second coordinate system centered on a centroid of locations of the plurality of audio output devices, and determining one or more locations of a source description of an audio object within the second coordinate system.

7. The computer-implemented method of any of clauses 1-6, further comprising determining an acoustics impulse response of each audio output device based on an acoustics model including at least one of a point-source acoustics model or a plane-wave acoustics model.

8. The computer-implemented method of any of clauses 1-7, further comprising: determining an acoustics impulse response of each audio output device based on the location of each audio output device within a second coordinate system.

9. The computer-implemented method of any of clauses 1-8, wherein generating the audio output of each audio output device further comprises applying a convolution operation to an audio representation of the audio object and the acoustics impulse response of the audio output device to generate an audio output device signal for output by the audio output device.

10. The computer-implemented method of any of clauses 1-9, further comprising: combining the audio output for a first audio output device of the plurality of audio output devices with a second audio output for a second audio object, wherein the second audio output is based on a location of the second audio object and the location of each audio output device relative to the other audio output devices; and causing the first audio output device to output the combined audio output.

11. In some embodiments, a non-transitory computer readable medium stores instructions that, when executed by a processor, cause the processor to perform the steps of: causing each audio output device of a plurality of audio output devices to output an audio sample; determining, for each other audio output device of the plurality of audio output devices, a detection time of the audio sample from each audio output device by each of two or more microphones included in the other audio output device; based on the detection times of each of the audio samples by each of the audio output devices, determining a location of each audio output device relative to the other audio output devices; and causing each of the plurality of audio output devices to generate an audio output including an audio object, wherein the audio output of each audio output device is based on a location of the audio object and the location of each audio output device relative to the other audio output devices.

12. The non-transitory computer readable medium of clause 11, wherein determining the location of a first audio output device of the plurality of audio output devices relative to the audio output device outputting the audio sample comprises: determining a difference between a first detection time of the audio sample by a first microphone of the first audio output device and a second detection time of the audio sample by a second microphone of the first audio output device, and determining, based on the difference, an angle between the first audio output device and the audio output device outputting the audio sample.

13. The non-transitory computer readable medium of clauses 11 or 12, wherein determining the location of a first audio output device of the plurality of audio output devices relative to the audio output device outputting the audio sample comprises: determining a difference between an emission time of the audio sample and a detection time of the audio sample by at least one of the two or more microphones of the first audio output device, and determining, based on the difference, a distance between the first audio output device and the audio output device outputting the audio sample.

14. The non-transitory computer readable medium of any of clauses 11-13, wherein determining the location of each audio output device relative to the other audio output devices comprises: for one or more pairs of the plurality of audio output devices, determining a triangle including an origin of a first coordinate system and a first location of each audio output device of the pair in the first coordinate system, determining a centroid of the plurality of audio output devices based on a weighted sum of centers of each triangle, wherein the weighted sum is based on areas of the triangles, and determining the location of each audio output device relative to the centroid.

15. The non-transitory computer readable medium of any of clauses 11-14, wherein the steps further comprise: determining a second location of each audio output device within a second coordinate system centered on a centroid of locations of the plurality of audio output devices, and determining one or more locations of a source description of an audio object within the second coordinate system.

16. The non-transitory computer readable medium of any of clauses 11-15, wherein the steps further comprise determining an acoustics impulse response of each audio output device, based on an acoustics model including at least one of a point-source acoustics model or a plane-wave acoustics model.

17. The non-transitory computer readable medium of any of clauses 11-16, wherein the steps further comprise determining an acoustics impulse response of each audio output device based on the location of each audio output device within a second coordinate system.

18. The non-transitory computer readable medium of any of clauses 11-17, wherein generating the audio output of each audio output device further comprises applying a convolution operation to an audio representation of the audio object and the acoustics impulse response of the audio output device to generate an audio output device signal for output by the audio output device.

19. In some embodiments, a system comprises: a memory storing instructions, and one or more processors that execute the instructions to perform steps comprising: causing each audio output device of a plurality of audio output devices to output an audio sample; determining, for each other audio output device of the plurality of audio output devices, a detection time of the audio sample from each audio output device by each of two or more microphones included in the other audio output device; based on the detection times of each of the audio samples by each of the audio output devices, determining a location of each audio output device relative to the other audio output devices; and causing each of the plurality of audio output devices to generate an audio output associated with an audio object, wherein an output of each of the audio output devices is based on a location of the audio object and the location of each audio output device relative to the other audio output devices.

20. The system of clause 19, wherein causing each of the plurality of audio output devices to generate the audio output further comprises: determining an acoustics impulse response of each audio output device, and applying a convolution operation to an audio representation of the audio object and the acoustics impulse response to generate an audio output device signal including the audio object by the audio output device.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method of generating audio, the method comprising:
causing each audio output device of a plurality of audio output devices to output an audio sample;
determining, for each other audio output device of the plurality of audio output devices, a detection time of the audio sample from each audio output device by each of two or more microphones included in the other audio output device;
based on the detection times of each of the audio samples by each of the audio output devices, determining a location of each audio output device relative to the other audio output devices; and
causing each of the plurality of audio output devices to generate an audio output associated with an audio object, wherein an output of each of the audio output devices is based on a location of the audio object and the location of each audio output device relative to the other audio output devices.

2. The computer-implemented method of claim 1, wherein determining the location of a first audio output device of the plurality of audio output devices relative to the audio output device outputting the audio sample comprises:
determining a difference between a first detection time of the audio sample by a first microphone of the first audio output device and a second detection time of the audio sample by a second microphone of the first audio output device, and
determining, based on the difference, an angle between the first audio output device and the audio output device outputting the audio sample.

3. The computer-implemented method of claim 1, wherein determining the location of a first audio output device of the plurality of audio output devices relative to the audio output device outputting the audio sample comprises:
determining a difference between an emission time of the audio sample and a detection time of the audio sample by at least one of the two or more microphones of the first audio output device, and
determining, based on the difference, a distance between the first audio output device and the audio output device outputting the audio sample.

4. The computer-implemented method of claim 1, wherein determining the location of each audio output device relative to the other audio output devices comprises:
determining a centroid of the plurality of audio output devices in a first coordinate system, and
determining the location of each audio output device relative to the centroid.

5. The computer-implemented method of claim 1, wherein determining the location of each audio output device relative to the other audio output devices comprises:
for one or more pairs of the plurality of audio output devices, determining a triangle including an origin of a first coordinate system and a first location of each audio output device of the pair in the first coordinate system, and
determining a centroid of the plurality of audio output devices based on a weighted sum of centers of each triangle, wherein the weighted sum is based on areas of the triangles.

6. The computer-implemented method of claim 1, further comprising:
determining a second location of each audio output device within a second coordinate system centered on a centroid of locations of the plurality of audio output devices, and
determining one or more locations of a source description of an audio object within the second coordinate system.

7. The computer-implemented method of claim 1, further comprising determining an acoustics impulse response of each audio output device based on an acoustics model including at least one of a point-source acoustics model or a plane-wave acoustics model.

8. The computer-implemented method of claim 1, further comprising:
determining an acoustics impulse response of each audio output device based on the location of each audio output device within a second coordinate system.

9. The computer-implemented method of claim 8, wherein generating the audio output of each audio output device further comprises applying a convolution operation to an audio representation of the audio object and the acoustics impulse response of the audio output device to generate an audio output device signal for output by the audio output device.

10. The computer-implemented method of claim 1, further comprising:
combining the audio output for a first audio output device of the plurality of audio output devices with a second audio output for a second audio object, wherein the second audio output is based on a location of the second audio object and the location of each audio output device relative to the other audio output devices; and
causing the first audio output device to output the combined audio output.

11. A non-transitory computer readable medium storing instructions that, when executed by a processor, cause the processor to perform the steps of:
causing each audio output device of a plurality of audio output devices to output an audio sample;
determining, for each other audio output device of the plurality of audio output devices, a detection time of the audio sample from each audio output device by each of two or more microphones included in the other audio output device;
based on the detection times of each of the audio samples by each of the audio output devices, determining a location of each audio output device relative to the other audio output devices; and
causing each of the plurality of audio output devices to generate an audio output including an audio object, wherein the audio output of each audio output device is based on a location of the audio object and the location of each audio output device relative to the other audio output devices.

12. The non-transitory computer readable medium of claim 11, wherein determining the location of a first audio output device of the plurality of audio output devices relative to the audio output device outputting the audio sample comprises:
determining a difference between a first detection time of the audio sample by a first microphone of the first audio output device and a second detection time of the audio sample by a second microphone of the first audio output device, and
determining, based on the difference, an angle between the first audio output device and the audio output device outputting the audio sample.

13. The non-transitory computer readable medium of claim 11, wherein determining the location of a first audio output device of the plurality of audio output devices relative to the audio output device outputting the audio sample comprises:
determining a difference between an emission time of the audio sample and a detection time of the audio sample by at least one of the two or more microphones of the first audio output device, and
determining, based on the difference, a distance between the first audio output device and the audio output device outputting the audio sample.

14. The non-transitory computer readable medium of claim 11, wherein determining the location of each audio output device relative to the other audio output devices comprises:
for one or more pairs of the plurality of audio output devices, determining a triangle including an origin of a first coordinate system and a first location of each audio output device of the pair in the first coordinate system,
determining a centroid of the plurality of audio output devices based on a weighted sum of centers of each triangle, wherein the weighted sum is based on areas of the triangles, and
determining the location of each audio output device relative to the centroid.

15. The non-transitory computer readable medium of claim 11, wherein the steps further comprise:
determining a second location of each audio output device within a second coordinate system centered on a centroid of locations of the plurality of audio output devices, and
determining one or more locations of a source description of an audio object within the second coordinate system.

16. The non-transitory computer readable medium of claim 11, wherein the steps further comprise determining an acoustics impulse response of each audio output device, based on an acoustics model including at least one of a point-source acoustics model or a plane-wave acoustics model.

17. The non-transitory computer readable medium of claim 11, wherein the steps further comprise determining an acoustics impulse response of each audio output device based on the location of each audio output device within a second coordinate system.

18. The non-transitory computer readable medium of claim 17, wherein generating the audio output of each audio output device further comprises applying a convolution operation to an audio representation of the audio object and the acoustics impulse response of the audio output device to generate an audio output device signal for output by the audio output device.

19. A system comprising:
a memory storing instructions, and
one or more processors that execute the instructions to perform steps comprising:
causing each audio output device of a plurality of audio output devices to output an audio sample;
determining, for each other audio output device of the plurality of audio output devices, a detection time of the audio sample from each audio output device by each of two or more microphones included in the other audio output device;
based on the detection times of each of the audio samples by each of the audio output devices, determining a location of each audio output device relative to the other audio output devices; and
causing each of the plurality of audio output devices to generate an audio output associated with an audio object, wherein an output of each of the audio output devices is based on a location of the audio object and the location of each audio output device relative to the other audio output devices.

20. The system of claim 19, wherein causing each of the plurality of audio output devices to generate the audio output further comprises:
determining an acoustics impulse response of each audio output device, and
applying a convolution operation to an audio representation of the audio object and the acoustics impulse response to generate an audio output device signal including the audio object by the audio output device.
